(19) United States
(12) Patent Application Publication
(10) Pub. No.: US 2026/0225606 A1
(43) Pub. Date: Aug. 6, 2026

(54) SYSTEMS AND METHODS FOR LEARNED ON-BOARD MAPS FOR AUTONOMOUS VEHICLES

(71) Applicant: Toyota Jidosha Kabushiki Kaisha, Toyota-shi (JP)

(72) Inventors: Ana Sofia Rufino Ferreira, Palo Alto, CA (US); Peyman Yadmellat, Palo Alto, CA (US); Yiming Zhang, Palo Alto, CA (US)

(73) Assignee: Toyota Jidosha Kabushiki Kaisha, Toyota-shi (JP)

(21) Appl. No.: 19/042,568

(22) Filed: Jan. 31, 2025

(51) Int. Cl. B60W 60/00; G01C 21/00

(52) U.S. Cl. CPC B60W 60/001; G01C 21/3885

(57) ABSTRACT

In one embodiment, an autonomous vehicle includes one or more processors and a non-transitory computer-readable medium storing instructions that, when executed by the one or more processors, cause the one or more processors to receive local scene data including an on-board map, input the local scene data into a data-driven planner and an iterative trajectory optimization planner, generate, using the data-driven planner, a DDP output includes a DDP trajectory and a DDP on-board map based at least in part on the local scene data, input the DDP output into the iterative trajectory optimization planner, where the DDP output is used as one or more costs of a plurality of costs of a cost function that is minimized by the iterative trajectory optimization planner, and the iterative optimization planner utilizes the DDP on-board map when minimizing the cost function, and generate, using the iterative trajectory optimization planner, an output trajectory.

### BACKGROUND

In an autonomous vehicle software stack, the planning module (i.e., “the planner”) is responsible for determining what an autonomous vehicle should do according to the current situation. One type of a planner is a rules-based planning module that selects a trajectory by minimizing a cost function that takes into account a plurality of costs, such as keeping within a lane boundary, speed limit, comfort (i.e., jerk control), obstacle avoidance, and others. As this type of planner is rules-based, it may cause the autonomous vehicle to maneuver in a manner that is not expected by a passenger, particularly when encountering complex scenarios. In some cases, the rules-based optimization planner may select a trajectory that feels unnatural, such as taking too wide of a turn when turning right or left at an intersection.

The rules-based optimization planner may utilize an on-board map that is a locally generated map using vehicle sensor data. For example, cameras on the vehicle capture image data surrounding the vehicle. An on-board map is created from this image data. The on-board map includes information such as the location of the road relative to the vehicle, the number of lanes, the presence and location of lane lines, and other road information. However, the area surrounding the vehicle captured by the vehicle sensors may be relatively small, resulting in a small field of view. Additionally, sensor data may be noisy or completely missing. For example, a sensor may be occluded or faulty. The resulting on-board map may be noisy or missing key details needed by the rules-based optimization planner.

Recently, machine learning (ML) planners have been developed. ML planners include a trained model that is trained by real-time human driving and/or simulated driving. ML planners may provide a more human-like driving experience, such as human-like lateral positioning with a lane, human-like turns and others. However, although ML planners can successfully navigate typical situations, ML planners may have difficulty in very rare scenarios. Additionally, ML planners may more frequently break rules of the road and behave in an unexpected manner. Further, the ML planner may produce trajectories that are commensurate with one driving style (e.g., aggressive) that are not commensurate with another driving style (e.g., passive), which may lead to passenger discomfort, unease, and/or frustration.

Accordingly, alternative autonomous vehicle planning modules and methods for training ML planners may be desired.

### BRIEF SUMMARY

In one embodiment, an autonomous vehicle includes one or more processors and a non-transitory computer-readable medium storing instructions that, when executed by the one or more processors, cause the one or more processors to receive local scene data including an on-board map, input the local scene data into a data-driven planner and an iterative trajectory optimization planner, generate, using the data-driven planner, a DDP output includes a DDP trajectory and a DDP on-board map based at least in part on the local scene data, input the DDP output into the iterative trajectory optimization planner, where the DDP output is used as one or more costs of a plurality of costs of a cost function that is minimized by the iterative trajectory optimization planner, and the iterative optimization planner utilizes the DDP on-board map when minimizing the cost function, and generate, using the iterative trajectory optimization planner, an output trajectory.

In another embodiment, a method of controlling an autonomous vehicle includes receiving local scene data, inputting the local scene data into a data-driven planner and an iterative trajectory optimization planner, generating, using the data-driven planner, a DDP output includes a DDP trajectory and a DDP on-board map based at least in part on the local scene data, inputting the DDP output into the iterative trajectory optimization planner, where the DDP output is used as one or more costs of a plurality of costs of a cost function that is minimized by the iterative trajectory optimization planner, and the iterative optimization planner utilizes the DDP on-board map when minimizing the cost function, generating, using the iterative trajectory optimization planner, an output trajectory, and controlling the autonomous vehicle according to the output trajectory.

In another embodiment, a computing apparatus includes one or more processors. The computing apparatus also includes a non-transitory computer-readable medium storing instructions that, when executed by the one or more processors, cause the one or more processors to receive local scene data including an on-board map, input the local scene data into a data-driven planner and an iterative trajectory optimization planner, generate, using the data-driven planner, a DDP output includes a DDP trajectory and a DDP on-board map based at least in part on the local scene data, input the DDP output into the iterative trajectory optimization planner, where the DDP output is used as one or more costs of a plurality of costs of a cost function that is minimized by the iterative trajectory optimization planner, and the iterative optimization planner utilizes the DDP on-board map when minimizing the cost function, and generate, using the iterative trajectory optimization planner, an output trajectory.

### BRIEF DESCRIPTION OF THE SEVERAL VIEWS OF THE DRAWINGS

FIG. 1 illustrates an example hybrid planner for an autonomous vehicle according to one or more embodiments described and illustrated herein.

FIG. 2 illustrates an example hybrid planner for an autonomous vehicle according to one or more embodiments described and illustrated herein.

FIG. 3 illustrates an example iterative trajectory optimization planner of a hybrid planner for an autonomous vehicle according to one or more embodiments described and illustrated herein.

FIG. 4 illustrates an example data flow of a hybrid planner for an autonomous vehicle according to one or more embodiments described and illustrated herein.

FIG. 5 illustrates a vehicle traveling on a road with a lane split.

FIG. 6 illustrates a workflow for generating a DDP on-board map using a data-driven planner according to one or more embodiments described and illustrated herein.

FIG. 7 illustrates a vehicle navigating an environment using a DDP on-board map according to one or more embodiments described and illustrated herein.

FIG. 8 illustrates a vehicle navigating another environment using a DDP on-board map according to one or more embodiments described and illustrated herein.

FIG. 9 illustrates an example autonomous vehicle according to one or more embodiments described and illustrated herein.

FIG. 10 illustrates example components of an autonomous vehicle according to one or more embodiments described and illustrated herein.

FIG. 11 illustrates an example method of controlling an autonomous vehicle according to one or more embodiments described and illustrated herein.

### DETAILED DESCRIPTION

Embodiments of the present disclosure are directed to autonomous vehicles having a software stack that includes a hybrid planning module (i.e., a hybrid planner) that combines attributes of both a machine learning (ML) planning module and a rules-based planning module. A ML planning module, referred to herein as a data-driven planner (DDP), utilizes a trained model to receive sensor and map data and produce a DDP trajectory. This DDP trajectory is then provided as an input to the rules-based planning module, referred to herein as an iterative trajectory optimization (ITO) planner, as a cost that is included among a plurality of other costs associated with a loss function.

Additionally, an on-board map generated from vehicle sensor data provides roadway information surrounding the vehicle, such as the number of lanes, the location of lane lines and other roadway information. In some cases, the distance-limitations of the vehicle sensors limits the field of view and the on-board map has a limited area surrounding the vehicle. In other cases, sensor occlusion or noise may cause the on-board map to be faulty or otherwise noisy. In embodiments, the data-driven planner receives the on-board map and predicts road features to provide a more accurate and robust DDP on-board map that is provided to the iterative trajectory optimization planner for use in generating the output trajectory.

The iterative trajectory optimization planner, using the DDP trajectory and the DDP on-board map, produces an output trajectory that is then converted into control signals that are used to autonomously control the autonomous vehicle.

The combination of both planner types takes advantage of the benefits of both a ML planner and rules-based optimization planner while minimizing the effect of their deficiencies. Inclusion of the DDP trajectory as a cost in the iterative trajectory optimization planner provides for a more human-like and natural trajectory executed by the autonomous vehicle that is appreciated by the passenger(s). The ML planner is leveraged to handle more complex scenarios, whereas the rules-based optimization planner is leveraged to handle rare events for which the ML planner has not been trained. Additionally, use of the iterative trajectory optimization planner ensures that the rules of the road are followed and that obstacles are avoided.

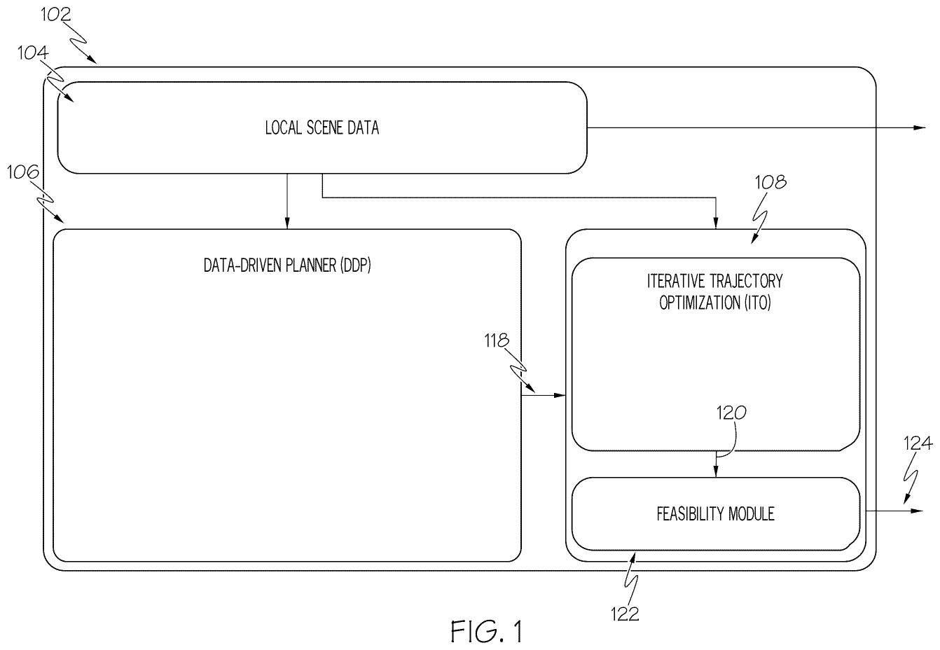

Referring now to FIG. 1, an example hybrid planner 102 of an autonomous software stack of an autonomous vehicle is schematically illustrated. It should be understood that other layers of the autonomous software stack are not shown for ease of illustration and brevity. The hybrid planner 102 generally includes a data-driven planner 106 that is machine-learning based and an iterative trajectory optimization planner 108 that is rules-based. The two planners are serially coupled such that the output of the data-driven planner 106 is provided as an input to the iterative trajectory optimization planner 108. Both the data-driven planner 106 and the iterative trajectory optimization planner 108 receive local scene data 104 that includes any type of data relating to the vehicle and the environment in which the autonomous vehicle is navigating. For example, the local scene data 104 may include vehicle sensor data, map data and external infrastructure data.

As described in more detail below, the data-driven planner 106 receives the local scene data 104 an produces a DDP output 118, which includes a DDP trajectory, using a machine-learning, data-driven approach. The DDP trajectory represents a path, speed and/or acceleration/deceleration of the vehicle that is human-like and thus typical of how a human driver would drive the autonomous vehicle.

The iterative trajectory optimization planner 108 receives the local scene data 104 and the DDP output 118 as inputs. As described in more detail below, the iterative trajectory optimization planner 108 includes a loss function that is minimized to generate an ITO trajectory 120. The loss function accounts for a plurality of costs, one or more of which are based on the DDP output 118. Thus, the iterative trajectory optimization planner 108 produces an ITO trajectory 120 that attempts to closely follow the DDP trajectory of the DDP output 118, while also taking into consideration all of the other costs of the iterative trajectory optimization planner 108.

In some embodiments, the ITO trajectory 120 outputted by the iterative trajectory optimization planner 108 is provided to a feasibility module 122, which, as described in more detail below, checks the feasibility of the ITO trajectory 120 with respect to several requirements. When the feasibility of the ITO trajectory 120 is established the feasibility module 122 outputs an output trajectory 124 that is then provided to one or more additional layers of the autonomous vehicle software stack. Ultimately, the output trajectory 124 is converted into one or more control signals that control one or more actuators of the autonomous vehicle to autonomously control the autonomous vehicle within the environment.

It is noted that FIG. 1 illustrates that the local scene data 104 may also be provided to other components of the autonomous vehicle, such as other layers of the autonomous vehicle software stack or other vehicular systems, such as an advanced driver assist system, as a non-limiting example.

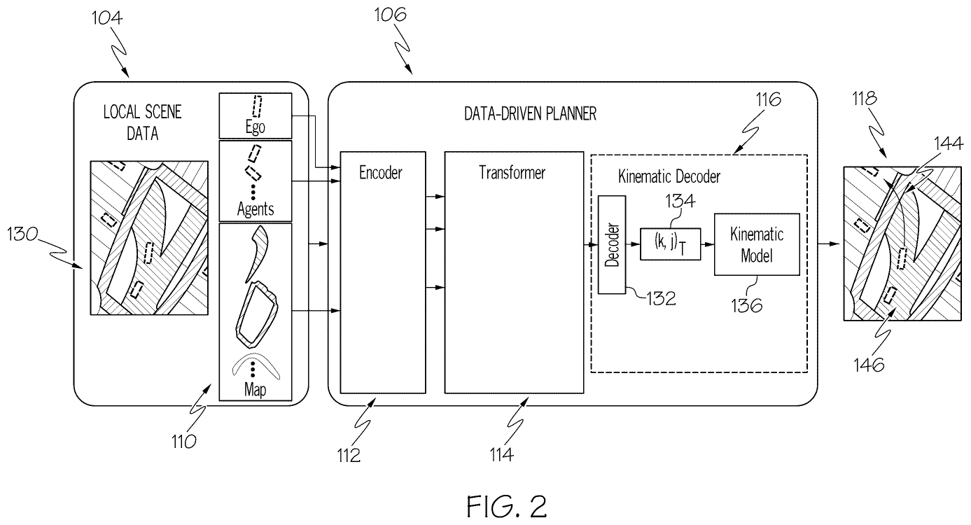

FIG. 2 illustrates the data-driven planner 106 in greater detail. It is noted that embodiments are not limited to the data-driven planner 106 of FIGS. 1 and 2, and that any machine-learning motion planner that produces a predicted trajectory may be utilized.

The local scene data 104, which may include vehicle sensor data, map data 130 (e.g., standard definition map data, enhanced standard definition map data, and/or high-definition map data), and infrastructure data (i.e., data obtained from sensors or other components external to the autonomous vehicle), is provided to the data-driven planner 106. In the example of FIG. 2, the local scene data 104 is processed into object representations 110, such as map representations, agent (e.g., other vehicles) representations, and ego (i.e., the autonomous vehicle) representations. More specifically, the object representations are vectorized polygon representations of the map data, agents and the autonomous vehicle. The vectorized object representations are referred to herein as “vectorized local scene data The local scene data that is converted into object representations by a vectorizer module. Each local scene object corresponds to one frame or timestep. As an example, the local scene data for consecutive frames is aggregated for consecutive frames and then passed to the vectorizer module, which converts the local scene representations to tensor/vectorized representations used an input to the data-driven planner 106.

The vectorized local scene data 104 is provided to the data-driven planner 106 as an input to a hierarchical graph network. The first level of the hierarchical graph network is an encoder that receives the vectorized local scene data and encodes it with local information. The object representations of the vectorized local scene data may include pose information, object type, time of observation, and other information.

For example, the encoder 112 may include two separate sub-components that generate two local subgraphs: one for encoding agents/ego, and one for encoding map elements of the local scene data. The ego/agents local subgraph captures temporal information for each agent over multiple frame (i.e., it is a temporal encoding network). The local map subgraph operates over all map elements in the current frame and is not capturing temporal information. As a non-limiting example, the encoder 112 may be a PointNet-based local subgraph. It should be understood that other encoder architectures may be used to generate an embedding vector for each agent, each map element, and the ego vehicle 138.

The second level of the hierarchical graph network is a transformer 114 generates a global embedding by combining the local information of the encoder 112. The global embedding of the transformer 114 is used for reasoning about interactions over agents and map features, and for translation into actions by way of a kinematic decoder 116. The transformer may include a transformer encoder architecture which uses multi-head self-attention plus feed-forward network blocks.

The global embeddings for each agent, each map element and the ego vehicle 138 may be provided to a kinematic decoder 116 that produces a DDP output 118 that includes a predicted trajectory. The kinematic decoder 116 may be used to ensure physical feasibility of the trajectory of the DDP output 118. More specifically, the kinematic decoder 116 includes a decoder 132 and a kinematic model 136. The kinematic decoder 116 receives the global embeddings from the transformer 114 and models the kinematics of the autonomous vehicle using a unicycle model. The kinematic decoder 116 may be a multilayer perceptron that predicts longitudinal jerk and curvature for each time step within a prediction horizon. The decoder 132 may be a neural network learnable module. The kinematic model 136, which may be a non-learnable model, receives these predictions as well as the current state of the autonomous vehicle to roll out the next state of the autonomous vehicle. The kinematic model 136 includes parameters for vehicle kinematic constraints, such as maximum allowed jerk, acceleration, curvature, and steering angle, which are used to clip controls to ensure physical feasibility. The result is the DDP output 118, which includes a DDP trajectory that is then provided to the iterative trajectory optimization planner 108 to be used as one or more costs.

In some embodiments, the kinematic decoder 116 is replaced by a learnable neural network decoder that is trained based on vehicle parameters and constraints. The neural network decoder may also be trained or fine-tuned using vehicle parameters to output physically feasible trajectories without the need for the kinematic decoder described above.

The data-driven planner 106 may be trained using imitation learning to train a driving policy that mimics expert driving behavior by minimizing the L1 loss between the poses generated by the model and ground truth poses. Perturbations to extend the distribution of states seen during training may be included and thus reduce the impact of the covariate shift. Large values of jerk and curvature may be penalized to reduce jerk and improve driving comfort. As a non-limiting example, the final loss is:

$$L = {\sum }_{t = 1}^{T} ‖ {p}_{t} - {\hat{p}}_{t} ‖ 1 + α ‖ {k}_{t} ‖ 2 + β ‖ {j}_{t} ‖ 2 , \qquad Eq . ( 1 )$$

Where pₜ is the predicted pose (xₜ, yₜ, θₜ) at time t, \hat{p}ₜ is the target pose, and α and β are hyperparameters.

It should be understood that embodiments of the present disclosure are not limited to training by imitation learning, and that other training methods may be utilized, such as reinforcement learning.

Additional information regarding the data-driven planner 106 is found at Vitelli et al., “SafetyNet: Safe planning for real-world self-driving vehicles using machine-learned policies.” As stated above, other machine-learning, data-based planner architectures may be used to produce a DDP output 118 that is used as a cost in a rules-based optimization planner, such as the iterative trajectory optimization planner 108.

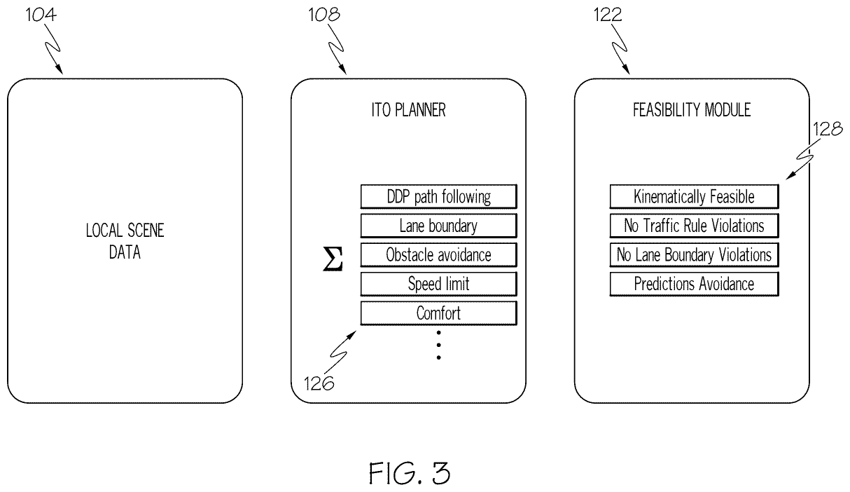

FIG. 3 illustrates the iterative trajectory optimization planner 108 and the feasibility module 122 in greater detail. The local scene data 104, which may include vehicle sensor data, map data (e.g., standard definition map data, enhanced standard definition map data, and/or high-definition map data), and infrastructure data (i.e., data obtained from sensors or other components external to the autonomous vehicle), is provided to the iterative trajectory optimization planner 108. The local scene data 104 may or not be processed in a manner that it suitable for it to be received by the iterative trajectory optimization planner 108.

The iterative trajectory optimization planner 108 solves a trajectory optimization problem in the form of a cost function. Any known or yet-to-be-developed trajectory optimization problem algorithm may be utilized. As a non-limiting example, iterative linear quadratic regulation (iLQR) may be used to solve a trajectory optimization problem that optimizes for a plurality of costs 126, one of which being the DDP output 118, and a plurality of hard and/or soft constraints (e.g., constraints on the optimization variables or any combinations of those variables). The plurality of costs 126 may include costs that are included in traditional rules-based optimization planners, such as, without limitation, lane boundary keeping, obstacle avoidance, speed limit, and comfort (i.e., jerk). The hard constraints may be, without limitation, obeying vehicle dynamics, maximum steering rate, and maximum jerk input. The soft constrains may be, without limitation, obstacle avoidance and lane boundary avoidance. The iterative trajectory optimization planner 108 outputs an ITO trajectory 120 having minimized costs associated with the cost function.

Embodiments are not limited by any particular cost function. The cost function may be engineered to have any type and number of costs. In embodiments of the present disclosure, the data-driven planner 106 provides the DDP output 118 to the iterative trajectory optimization planner 108. The DDP output 118 may provide any number of costs to the iterative trajectory optimization planner 108. For example, the DDP output may provide a DDP path cost (i.e., the path the autonomous vehicle travels), a DDP speed cost (i.e., the speed the vehicle travels), and/or DDP heading cost (i.e., the heading of the autonomous vehicle).

More specifically, a trajectory includes a sequence of future states to be visited by the vehicle, and may be parameterized by factors such as time, travelled distance and other parameters. Accordingly, a trajectory may be a sequence of waypoints {wᵢ}=0, . . . , N, each associated with a time instance, tᵢ. Time instance, tᵢ, may range in some examples from some initial time to a planning horizon look-ahead time t_{N}. The waypoints may be vectors typically consisting of vehicle Cartesian coordinates, heading angle (orientation), velocity and acceleration. If the waypoint time evolution is governed by some dynamics equations, the waypoints may be referred to as state vectors or states.

A non-limiting optimized-based motion plan of the iterative trajectory optimization planner 108 may be formulated in its generic discrete-time form as:

$${min}_{{u}_{0} , {u}_{N - 1}} J ( w , u ) = {ℓ}_{N} ( {w}_{N} ( {t}_{N} ) ) + {\sum }_{i = 0}^{N - 1} {ℓ}_{i} ( {w}_{i} , {u}_{i} ) , \qquad Eq . ( 2 a )$$

$$subject to : {w}_{i + 1} = f ( {w}_{i} , {u}_{i} ) , \qquad Eq . ( 2 b )$$

$$( {w}_{i} , {u}_{i} ) ∈ {C}_{i} , i = 0 … , N - 1 , \qquad Eq . ( 2 c )$$

$${w}_{N} ∈ {C}_{N} , . \qquad Eq . ( 2 d )$$

Where Eq. (2a) represents the cost function that is being optimized (in this case-minimized) by a selection of control inputs {uᵢ}. Equation (2b) represents dynamics equations derived from the vehicle dynamics model, that define how the control inputs affect the evolution of waypoints (states) and Eq. (2c)-(2d) define constraints on waypoints (states) and on control variables. Components lᵢ promote or regulate behaviors such as, for example, lane following, maintaining a distance from obstacles, motion progress along the lane, and comfort metrics.

The ITO trajectory 120 produced by the iterative trajectory optimization planner 108 is then provided to the feasibility module 122, which checks the feasibility according to several characteristics 128, such as kinematic feasibility, legality (i.e., no traffic rule violations), no lane boundary violations, and collision likelihood. For kinematic feasibility, the feasibility module 122 evaluates whether the ITO trajectory 120 remains within a feasible envelope characterized by the dynamics limits of the autonomous vehicle. More particularly, the feasibility module 122 evaluates each trajectory state of the ITO trajectory 120 and determines whether parameters such as longitudinal jerk, longitudinal acceleration, curvature, curvature rate, lateral acceleration, and steering jerk (curvature rate×velocity) are within acceptable bounds. Lane boundary feasibility checks to determine that each stage of the ITO trajectory 120 remains within the lane boundaries of the road. The legality feasibility checks each stage of the ITO trajectory 120 to make sure no traffic rules are violated, such as running a stop sign, violation of the right of way, running a red traffic light, and leaving a drivable surface, as non-limiting examples. The collision likelihood feasibility checks each stage of the ITO trajectory 120 for the likelihood of a collision with any other road agents using a prediction model that predicts poses of the other road agents. Generally collision detection may be performed by rasterizing future agent predictions and checking for overlaps with planned poses of the autonomous vehicle over the ITO trajectory.

When the feasibility module 122 indicates an ITO trajectory 120 is feasible, it is outputted as an output trajectory 124 that is ultimately used to control the autonomous vehicle. If the ITO trajectory 120 is infeasible, a fallback trajectory may be utilized, such as another candidate ITO trajectory 120.

In embodiments where the 108 receives multiple DDP outputs 118 from the data-driven planner 106, the iterative trajectory optimization planner 108 may select a single DDP output 118 as one or more costs to optimize. For example, the data-driven planner 106 may output a confidence score for each DDP output 118 and the iterative trajectory optimization planner 108 may select an individual DDP output 118 based on the confidence scores (e.g., select the DDP output 118 having the highest confidence score). As another example, the iterative trajectory optimization planner 108 may produce multiple ITO trajectories 120 using each DDP output 118 as one or more costs in individual optimizations. The feasibility module 122 may evaluate each of the ITO trajectories 120 and select the ITO trajectory 120 that is most feasible to be used as the output trajectory 124, for example.

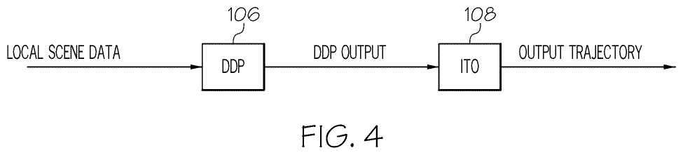

FIG. 4 is a simplified diagram of FIG. 1. As shown in FIG. 4, local scene data is provided as input to a data-driven planner 106, which produces a DDP output 118 that includes a predicted trajectory. The predicted trajectory of the data-driven planner 106 is provided as an input to an iterative trajectory optimization planner 108. The iterative trajectory optimization planner 108 uses the DDP output 118 as one or more costs to be minimized in a rules-based optimization planner. The one or more costs associated with the DDP output 118 included with a plurality of other costs that are to be minimized by the iterative trajectory optimization planner 108, such as lane keeping, speed limit and others. The iterative trajectory optimization planner 108 produces an output trajectory that is then used to control the autonomous vehicle within an environment without human intervention.

Referring once again to FIG. 1, at least a portion of the local scene data 104 may be provided to both the data-driven planner 106 and the iterative trajectory optimization planner 108 as an on-board map (also referred to as a local map) derived from sensor data, such as vehicle sensor data and environmental sensor data. For example, the local scene data 104 may include camera data that is processed by another vehicle component to generate an on-board map showing lane lines, lane locations, road shoulders and other roadway features. This on-board map of the local scene data 104 is used by the iterative trajectory optimization planner 108 to generate an optimal trajectory for the vehicle 138 to perform.

However, the local scene data 104 may be noisy and therefore the resulting on-board map may also be noisy. The on-board map may be missing details for various reasons, such as one or more cameras being occluded, limited field of view for the camera or other sensors, or other reasons. When the on-board map is noisy and/or has missing information, the iterative trajectory optimization planner 108 may not be able to successfully produce an output trajectory 124, leading to an undesirable result.

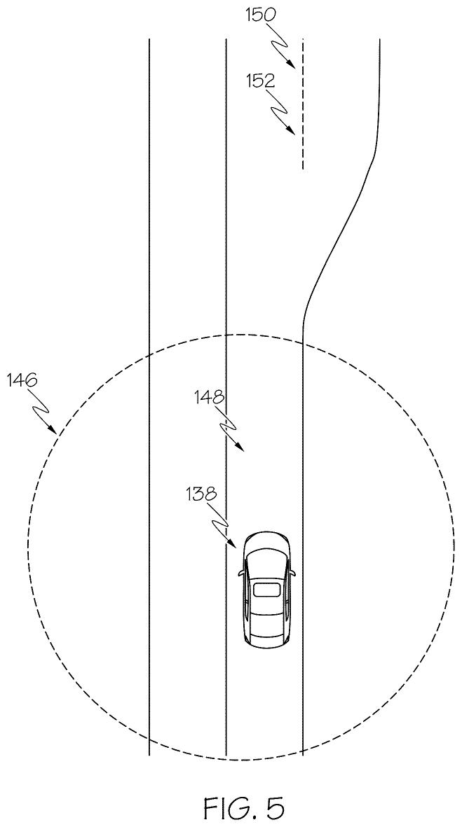

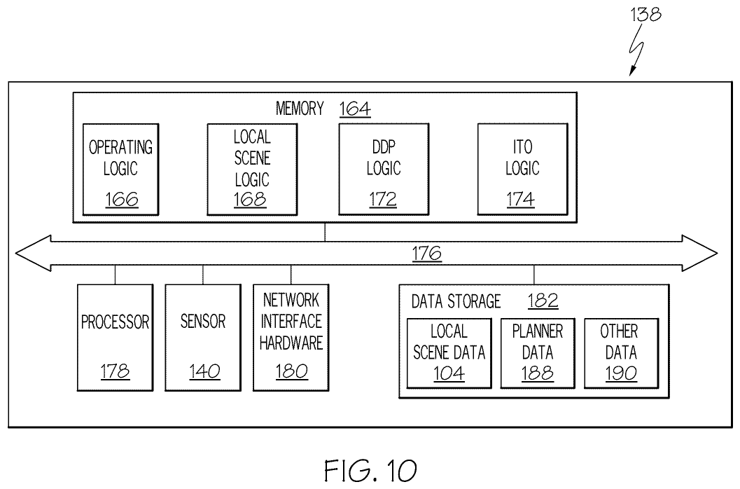

Referring now to FIG. 5, a vehicle traveling with a single lane 148 of a road is illustrated. The vehicle 138 includes sensors 140 (see FIG. 10) that are used to gather data of the surrounding environment to generate an on-board map that includes information such as lane lines, road shoulder, and other road features. The sensors 140 have a field of view 146 surrounding the vehicle at a certain radius. Thus, the on-board map only extends a certain distance from the vehicle 138 within the field of view 146. Features of the road beyond the field of view 146 are not provided within the on-board map that is generated and provided to the iterative trajectory optimization planner 108.

In the illustrated example there is a lane split 150 created by the addition of lane lines 152 whereby the single lane 148 becomes two lanes. However, the on-board map provided to the iterative trajectory optimization planner 108 does not include the lane split 150 yet because it is out of the field of view 146. The on-board map will not include the lane split 150 until the vehicle is closer to the lane split 150 and the lane split 150 is within the field of view 146. The on-board map may not include the lane split 150 in enough time for the iterative trajectory optimization planner 108 to utilize the lane split 150 when generating an output trajectory.

In embodiments of the present disclosure, the data-driven planner 106 receives both the local scene data 104 (which includes the on-board map) and map data to create a DDP on-board map that includes learned supplemental information that is not in the original on-board map. In the example of FIG. 5, a standard definition map (“SD map”) or an enhanced SD map includes some road information, such as the number of lanes. The data-driven planner 106 is trained to understand that a lane split 150 is ahead and that lane lines 152 will be present at the lane split 150. The data-driven planner 106 outputs a DDP on-board map that includes the addition of lane lines 152 as well as a wider road to accommodate the lane split 150 before the vehicle 138 reaches the lane split 150 at a position where the lane split 150 is within the field of view 146. Therefore, the iterative trajectory optimization planner 108 may use this supplemental information of the DDP on-board map earlier than it would have received the an on-board map including the lane split 150. In this manner, the iterative trajectory optimization planner 108 has additional time to account for the lane split 150 when producing an output trajectory.

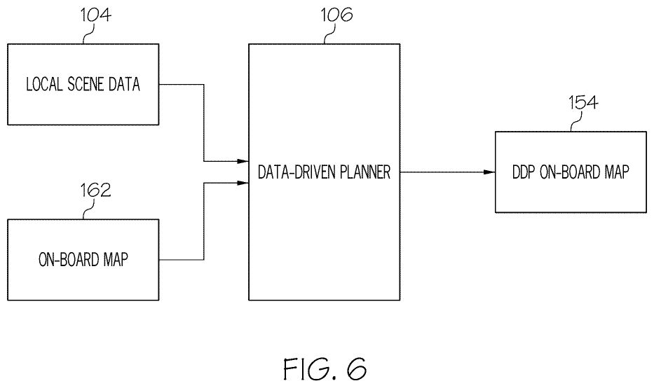

FIG. 6 illustrates an example workflow for producing a DDP on-board map 154. The data-driven planner 106 receives the local scene data 104, which may include the sensor data generated by the sensors of the vehicle 138, as well as any data from external sensors or devices. The local scene data also includes map data 130 (see FIG. 1), such as map data 130 from a SD map or an enhanced SD map.

The data-driven planner 106 may also receive an on-board map 162 generated by another vehicle component or module using the local scene data 104. In other embodiments, the data-driven planner 106 does not receive an on-board map. The data-driven planner 106 is trained to produce a DDP on-board map 154 based on the local scene data 104 and, in some embodiments, the on-board map 162. The DDP on-board map 154 may include additional information beyond an on-board map 162. In other words, the data-driven planner 106 is trained to include additional information that is expected based on the local scene data 104 that is not presently included in the on-board map 162 generated from the local scene data 104. In the example of FIG. 5, the map data 130 indicates a lane split 150 a certain distance from the vehicle 138, and the data-driven planner 106 predicts that there should be lane lines 152 associated with the lane split 150. If there are no lane lines 152 within the on-board map 162, the data-driven planner 106 may supplement the on-board map 162 with the lane lines 152 in its DDP on-board map 154. As a non-limiting example, the data-driven planner 106 may be trained by using ground truth local scene data, map data and on-board maps.

In some embodiments, a local map builder module receives both local scene data and the supplemental information from the data-driven planner. The local map builder module then generates features of the local map, such as lane lines. The enhanced local map generated by the local map builder module is then provided to the iterative trajectory optimization planner 108.

Accordingly, the DDP on-board map 154 provides more detail and more accurate information to the iterative trajectory optimization planner 108 than an on-board map alone.

The data-driven planner 106 may provide additional and/or more accurate information in its DDP on-board map 154. For example, one or more sensors 140 may be occluded (e.g., by an obstacle or debris), may be noisy, or may malfunction. The data-driven planner 106 supplements the on-board map with details/features that it predicts should be present within the on-board map and generates the DDP on-board map 154 accordingly.

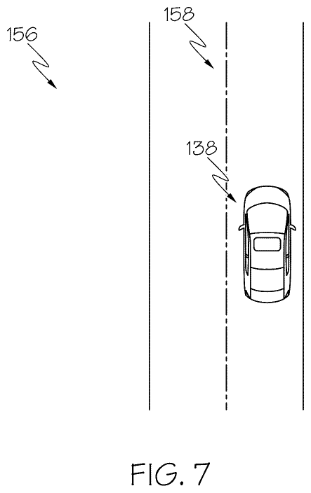

FIG. 7 illustrates an example where a vehicle 138 is traveling on a road 156 that has no lane lines. There may be no lane lines because they were never painted on the road 156, or they are too faded to be picked up by the sensors 140 of the vehicle 138. In such an instance, the data-driven planner 106 understands that the road is a two-lane road from the map data 130, and therefore produces DDP lane lines 158 (shown as a dash-dot line in FIG. 7) that are produced in the DDP on-board map 154 provided to the iterative trajectory optimization planner 108. The iterative trajectory optimization planner 108 then uses the DDP lane lines 158 of the DDP on-board map 154 in generating a trajectory such that the vehicle travels with the corridor established by the DDP lane lines 158.

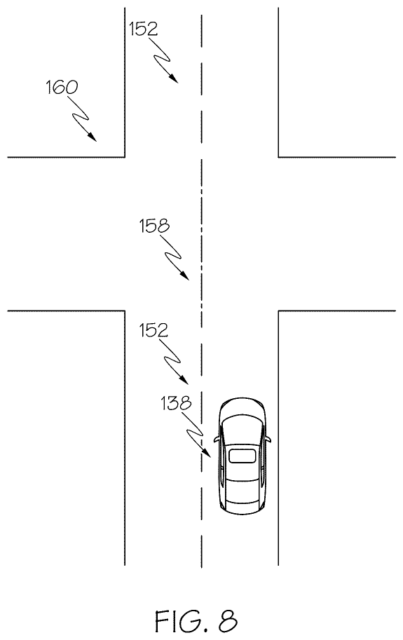

FIG. 8 illustrates another use-case of the DDP on-board map 154. In FIG. 8, a vehicle 138 is approaching an intersection 160. As is typical of most intersections, the intersection 160 does not include lane lines. The data-driven planner 106, knowing that an intersection is approaching based on the map data 130 and/or the on-board map provided by the local scene data 104, may predict where lane lines should be present within the intersection 160 as if the intersection 160 was not present. The data-driven planner 106 may therefore insert one or more DDP lane lines 158 on the DDP on-board map 154, such as shown in FIG. 8. Other use-cases are also possible.

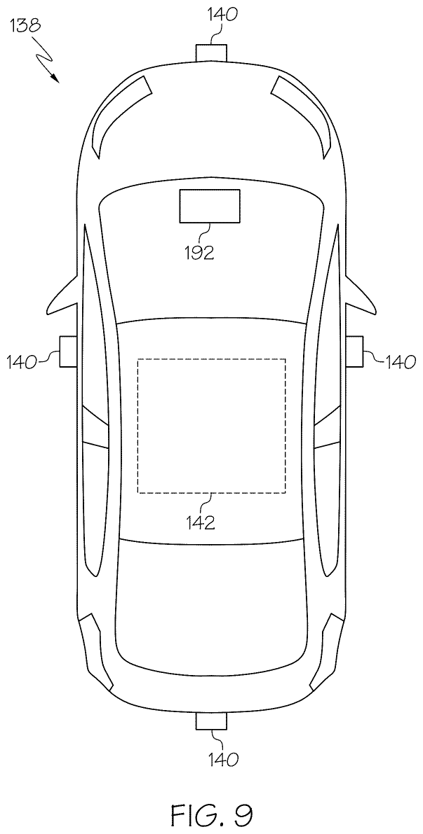

Referring now to FIG. 9, an example autonomous vehicle 138 is schematically illustrated. The vehicle 138 may be any type of autonomous vehicle. For example, the autonomous vehicle 138 may be a Level 4 or a Level 5 autonomous vehicle capable of driving without human intervention. The illustrated autonomous vehicle 138 has any number of sensors 140 that produce sensor data representing the local scene, such as cameras, lidar sensors, radar sensors, proximity sensors, speedometers, inertial measurement units (IMU), steering angle sensors, braking sensors, occupancy sensors, and any other sensor capable of detecting an attribute of the autonomous vehicle 138 and the environment in which the autonomous vehicle 138 is navigating. The sensors of the autonomous vehicle 138 also includes a global positioning system (GPS) device configured to receive locational data from one or more satellites orbiting the Earth. The autonomous vehicle 138 has an autonomous driving autonomous driving system 142 including a software stack capable of receiving sensor data from the plurality of sensors 140 and any other data source, and generating a trajectory that is used by the autonomous vehicle 138 to drive within the environment, including the hybrid planner 102 described herein.

The autonomous vehicle 138 also includes a plurality of actuator 192 operable to receive control signals from the autonomous driving system 142 and produce motion to move the autonomous vehicle within the environment. The actuator 192 may be, without limitation, an electric motor, an engine, a steering system, a brake, an accelerator, and any other component that produces physical movement of the autonomous vehicle 138. The hybrid planner 102 produces an output trajectory 124 that is converted into control signals by the autonomous driving system 142, which are then provided to the plurality of actuators that moves the vehicle such that it completes the output trajectory 124.

Referring now to FIG. 10, components of an example autonomous vehicle 138 are illustrated. The example autonomous vehicle 138 provides a system for producing an output trajectory and controlling an autonomous vehicle, and/or a non-transitory computer usable medium having computer readable program code for producing a trajectory and autonomously controlling the vehicle embodied as hardware, software, and/or firmware, according to embodiments shown and described herein. It should be understood that the software, hardware, and/or firmware components depicted in FIG. 10 may also be provided in multiple computing apparatuses or devices external to autonomous vehicle 138 depicted in FIG. 10 (e.g., data storage devices, remote server computing devices, and the like).

As also illustrated in FIG. 10, the autonomous vehicle 138 (or other computing apparatus) may include a one or more processors 178, one or more sensors 140, network interface hardware 180, and a data storage component 182 (which may store local scene data 104, planner data 188, and any other data 190 for performing the functionalities described herein), and a non-transitory memory component 164. The non-transitory memory component 148 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components. In other embodiments, the memory component 148 may be defined by transitory memory and/or signals.

Additionally, the non-transitory memory component 164 may be configured to store operating logic 166 that provides a local operating system for the autonomous vehicle 138, local scene logic 168 for receiving and processing local scene data 104, DDP logic 172 for producing a DDP output that includes a predicted trajectory and a DDP on-board map, and ITO logic 174 for receiving the DDP output and generating a rules-based output trajectory for controlling the autonomous vehicle 138 (each of which may be embodied as computer readable program code, firmware, or hardware, as an example). It should be understood that the data storage component 182 may reside local to and/or remote from the autonomous vehicle 138, and may be configured to store one or more pieces of data for access by the autonomous vehicle 138 and/or other components.

A local interface 176 is also included in FIG. 10 and may be implemented as a bus or other interface to facilitate communication among the components of the autonomous vehicle 138.

The one or more processors 178 may include any processing component configured to receive and execute computer readable code instructions (such as from the data storage component 182 and/or non-transitory memory component 164). The network interface hardware 180 may include any wired or wireless networking hardware, such as a modem, LAN port, wireless fidelity (Wi-Fi) card, WiMax card, mobile communications hardware, and/or other hardware for communicating with other networks and/or devices.

Included in the non-transitory memory component 164 may be the operating logic 166, local scene logic 168, DDP logic 172, and ITO logic 174. The operating logic 166 may include an operating system and/or other software for managing components of the autonomous vehicle 138 or computing apparatus. The local scene logic 168 may reside in the non-transitory memory component 164 and may be configured to receive local scene data 104 (e.g., sensor data and map data) and render or otherwise process the local scene data 104 for use by the DDP logic 172 and the ITO logic 174 (e.g., vectorize the local scene data into a plurality of object representations 110). The DDP logic 172 also may reside in the non-transitory memory component 164 and may be configured to produce a DDP output that includes a predicted trajectory based on the local scene data 104, as well as a DDP on-board map. The ITO logic 174 also may reside in the non-transitory memory component 164 and may be configured to receive the DDP output and generate a rules-based output trajectory using the DDP output as one or more costs that are minimized using a cost function. The output trajectory is used by the autonomous vehicle 138 for autonomous navigation.

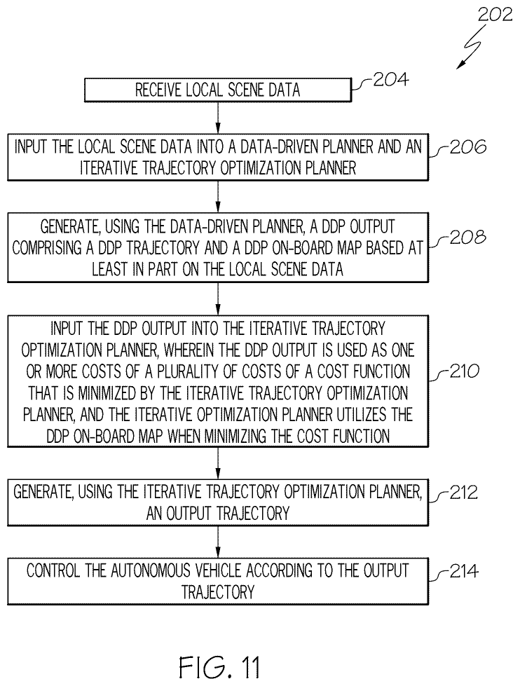

FIG. 11 illustrates an example method 202 of controlling an autonomous vehicle is illustrated. In block 204, the method 202 includes receiving local scene data. In block 206, the method 202 inputs the local scene data into a data-driven planner and an iterative trajectory optimization planner. In block 208, a DDP output comprising a DDP trajectory and a DDP on-board map are generated using the data-driven planner based at least in part on the local scene data. In block 210, the method 202 inputs the DDP output into the iterative trajectory optimization planner, wherein the DDP output is used as one or more costs of a plurality of costs of a cost function that is minimized by the iterative trajectory optimization planner, and the iterative optimization planner utilizes the DDP on-board map when minimizing the cost function. In block 212, the method includes generating, using the iterative trajectory optimization planner, an output trajectory. Finally, in block 214, the method includes controlling the autonomous vehicle according to the output trajectory.

It should be understood that the components illustrated in FIG. 10 are merely exemplary and are not intended to limit the scope of this disclosure. More specifically, while the components in FIG. 10 are illustrated as residing within the autonomous vehicle 138, this is a non-limiting example. In some embodiments, one or more of the components may reside external to the autonomous vehicle 138.

It should now be understood that embodiments of the present disclosure are directed to autonomous vehicles having a software stack that includes a hybrid planner that combines attributes of both a machine learning planner and a rules-based optimization planner. The rules-based optimization planner ensures that the autonomous vehicle follows a smooth trajectory, satisfies rules of the road, and avoids obstacles. The machine learning planner (i.e., the data-driven planner) ensures a more human-like trajectory by producing a predicted trajectory that is provided to the rules-based optimization planner, which uses the predicted trajectory as a cost among a plurality of costs that are minimized to produce the output trajectory that the autonomous vehicle follows. By including the predicted trajectory as a cost, the rules-based optimization planner will attempt to select an output trajectory that closely follows the predicted trajectory, while also considering the other costs of the cost function. In this manner, the autonomous vehicle may follow a more human-like trajectory. The machine-learning planner further may generate a learned on-board map that includes more information (and more accurate) than an on-board map generated from vehicle data alone. This learned on-board map may then be used by the rules-based optimization planner in lieu of the on-board map generated solely from vehicle sensor data.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An autonomous vehicle comprising:
one or more processors;
a non-transitory computer-readable medium storing instructions that, when executed by the one or more processors, cause the one or more processors to:
receive local scene data including an on-board map;
input the local scene data into a data-driven planner and an iterative trajectory optimization planner;
generate, using the data-driven planner, a DDP output comprising a DDP trajectory and a DDP on-board map based at least in part on the local scene data;
input the DDP output into the iterative trajectory optimization planner, wherein the DDP output is used as one or more costs of a plurality of costs of a cost function that is minimized by the iterative trajectory optimization planner, and the iterative trajectory optimization planner utilizes the DDP on-board map when minimizing the cost function; and
generate, using the iterative trajectory optimization planner, an output trajectory.

2. The autonomous vehicle of claim 1, further comprising a plurality of sensors that generate sensor data, wherein the local scene data comprises the sensor data and map data.

3. The autonomous vehicle of claim 1, wherein the data-driven planner comprises an encoder that encodes vectorized local data and a transformer that combines encoded local scene data from the encoder into a global embedding.

4. The autonomous vehicle of claim 3, wherein the data-driven planner further comprises a kinematic decoder that, using the global embedding, generates the DDP output.

5. The autonomous vehicle of claim 1, wherein the DDP on-board map comprises features not present in the on-board map.

6. The autonomous vehicle of claim 1, wherein the DDP on-board map comprises lane lines not present in the on-board map.

7. The autonomous vehicle of claim 1, further comprising one or more actuators, wherein the instructions further cause the one or more processors to:
generate one or more control signals from the output trajectory; and
provide the one or more control signals to the one or more actuators to move the autonomous vehicle within an environment.

8. A method of controlling an autonomous vehicle, the method comprising:
receiving local scene data including an on-board map;
inputting the local scene data into a data-driven planner and an iterative trajectory optimization planner;
generating, using the data-driven planner, a DDP output comprising a DDP trajectory and a DDP on-board map based at least in part on the local scene data;
inputting the DDP output into the iterative trajectory optimization planner, wherein the DDP output is used as one or more costs of a plurality of costs of a cost function that is minimized by the iterative trajectory optimization planner, and the iterative trajectory optimization planner utilizes the DDP on-board map when minimizing the cost function;
generating, using the iterative trajectory optimization planner, an output trajectory; and
controlling the autonomous vehicle according to the output trajectory.

9. The method of claim 8, wherein the local scene data comprises map data and sensor data generated by one or more sensors of the vehicle.

10. The method of claim 8, wherein the data-driven planner comprises an encoder that encodes vectorized local scene data and a transformer that combines encoded local scene data from the encoder into a global embedding.

11. The method of claim 8, wherein the data-driven planner further comprises a kinematic decoder that, using the global embedding, generates the DDP output.

12. The method of claim 8, wherein the DDP on-board map comprises features not present in the on-board map.

13. The method of claim 8, wherein the DDP on-board map comprises lane lines not present in the on-board map.

14. The method of claim 8, wherein controlling the autonomous vehicle comprises generating one or more control signals from the output trajectory, and providing the one or more control signals to one or more actuators of the autonomous vehicle.

15. A computing apparatus comprising:
one or more processors;
a non-transitory computer-readable medium storing instructions that, when executed by the one or more processors, cause the one or more processors to:
receive local scene data including an on-board map;
input the local scene data into a data-driven planner and an iterative trajectory optimization planner;
generate, using the data-driven planner, a DDP output comprising a DDP trajectory and a DDP on-board map based at least in part on the local scene data;
input the DDP output into the iterative trajectory optimization planner, wherein the DDP output is used as one or more costs of a plurality of costs of a cost function that is minimized by the iterative trajectory optimization planner, and the iterative trajectory optimization planner utilizes the DDP on-board map when minimizing the cost function; and
generate, using the iterative trajectory optimization planner, an output trajectory.

16. The computing apparatus of claim 15, wherein the local scene data comprises map data and sensor data generated by one or more sensors of the autonomous vehicle.

17. The computing apparatus of claim 15, wherein the data-driven planner comprises an encoder that encodes vectorized local data and a transformer that combines encoded local scene data from the encoder into a global embedding.

18. The computing apparatus of claim 15, wherein the data-driven planner further comprises a kinematic decoder that, using the global embedding, generates the DDP output.

19. The computing apparatus of claim 15, wherein the DDP on-board map comprises features not present in the on-board map.

20. The computing apparatus of claim 15, wherein the DDP on-board map comprises lane lines not present in the on-board map.
